(19) United States
(12) Patent Application Publication
(10) Pub. No.: US 2004/0212219 A1
(43) Pub. Date: Oct. 28, 2004

(54) Active air foil

(76) Inventor: Darrick Charles Weaver, Dallas, TX (US)

Correspondence Address: Darrick Weaver, 9801 NIXON DRIVE, McKINNEY, TX, 75070, US

(21) Appl. No.: 10/419,299

(22) Filed: Apr. 22, 2003

(51) Int. Cl. B62D 35/00

(52) U.S. Cl. 296/180.5

(57) ABSTRACT

An active air foil system for deflecting, capturing and or ducting the air passing over the surface of a moving automobile. The active air foil system includes: (a) a foil panel having two or more bracket hinges attached to a mounting base on the leading or trailing end and two brackets attached to an extension lever assembly, which is connected more or less midway of the panel. (b) an actuating device that provides the force that will present the foil panel to the air stream passing over the vehicle. (c) an extension lever assembly being designed in such a way that it will adjust the width of itself to the shape of the area that it is being mounted to and also moving along lever guides (d) lever guides that provide a bracing point for the extension lever assembly when the foil panel is opened and closed (e) foil panel hinges that provide a pivoting point for the foil panel when it is opened and closed (f) foil mounts that will allow the smooth transition of the foil panel to its open and closed position. (g) lever stops that will prevent the actuating device from receiving damaging levels of stress and also will keep the panel from opening more than desired (h) actuating device bracket which will provide a mounting point for the end of the actuating device housing (i) an aerodynamic cover which will help to reduce drag and give the entire system a more appealing finish. (j) a protective pad that will protect the vehicle from the active air foil system base. (k) mid-brace to keep the actuating device from moving up and down in relation to the foil system. (l) a base plate which provides a mounting surface for the components inside the active air foil system.

### FIELD OF THE INVENTION

This invention is related to the speed brake system on aircraft, but strictly designed for automobiles. It will actively assist in slowing a vehicle, ducting air for cooling or capturing air and ramming it into auto intakes.

### BACKGROUND OF THE INVENTION

In the past there have been few vehicles offered that enabled passenger cars to utilize the air passing over it in any fashion. Typically, most vehicles utilize static means of providing extra cooling, braking or air ducting. When these systems are not needed they are still in their operating position, which could sometimes cause unwanted drag.

### BRIEF SUMMARY OF THE INVENTION

This invention can be installed on any section of a vehicle where the following is needed and does not always have to be in a position where it is being used if not necessary.

(a) Cooling: many systems on a vehicle operate better at lower temperatures. With the active airfoil system the user can have it open or in use when the vehicle is at it's height of operation and closed or not in use when the vehicle is in normal operation.

(b) Braking: the braking system on a car is usually sufficient, but during extreme operation the vehicle could use a secondary system that could assist the main braking system when it is in operation. This secondary braking system is opened when the main system is engaged and closed when the main system is disengaged.

(c) Air charging: many performance vehicles have aftermarket intake systems that help provide a denser air charge to the combustion chamber, but usually these systems consist of larger filters that pull in under hood air. This is usually high temperature air that can defeat the purpose of having a larger intake filter. The active air foil system can provide a cooler denser charger of air from the air passing around the vehicle and can also be in use when desired.

### BRIEF DESCRIPTION OF THE DRAWINGS

FIG. 1. is a side downward looking view of the system showing it in the open position.

FIG. 2. is a top view of the system showing the necessary configuration of the components.

### DETAILED DESCRIPTION OF THE INVENTION

The active air foil systems size depends on the size of the area where it will be installed. The effect of the system depends on whether the user wants it to capture air or deflect it, which is simply a matter of orienting the system with the opening end facing to the front of the vehicle or the rear. The materials used can be plexi-glass or aluminum for the foil and base and foam rubber for the aero-cover. If the user decides to reposition the system from one configuration to the other all that is needed is to turn the system 180 degrees from the previous orientation and also do the same with the actuator and extension levers.

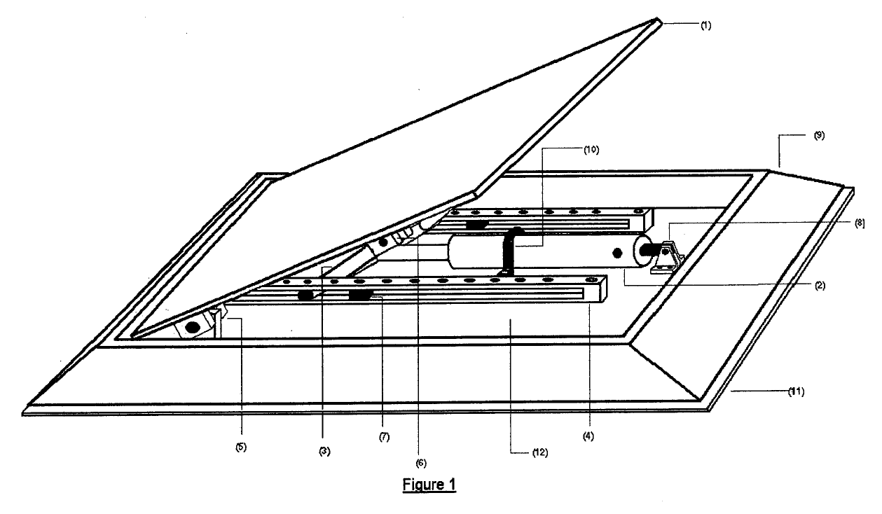

Referring now to FIG. 1 which is a side downward looking view of the system showing it in the open position. Exposed is the actuating device 2 which provides the force needed to open and close the foil panel 1. The actuating device bracket 8 provides the actuating device 2 with a bracing point to push against when activated. As illustrated the extension lever assembly 3 is connected to the foil panel 1 by foil brackets 6 and actually pushes or pulls the foil panel 1 into position. The foil panel 1 is connected to the base plate 12 by and also pivots on foil panel hinges 5. The extension lever assembly 3 is connected also to the actuating device 2 and also moves along lever guides 4 which house lever stops 7 which prevent the extension levers 3 from moving too far along the lever guides 4 and also prevents damaging levels of stress from overloading the actuating device 2. The entire assembly is mounted on the vehicle by means of a base plate 12 which also provides a ridged surface for the system to work against. To cover the system and help direct air over and around the system an aerodynamic cover 9 surrounds the system. This also helps to blend the system in with the lines of the vehicle. A protective pad 11 protects the vehicle from damage from the base plate 12.

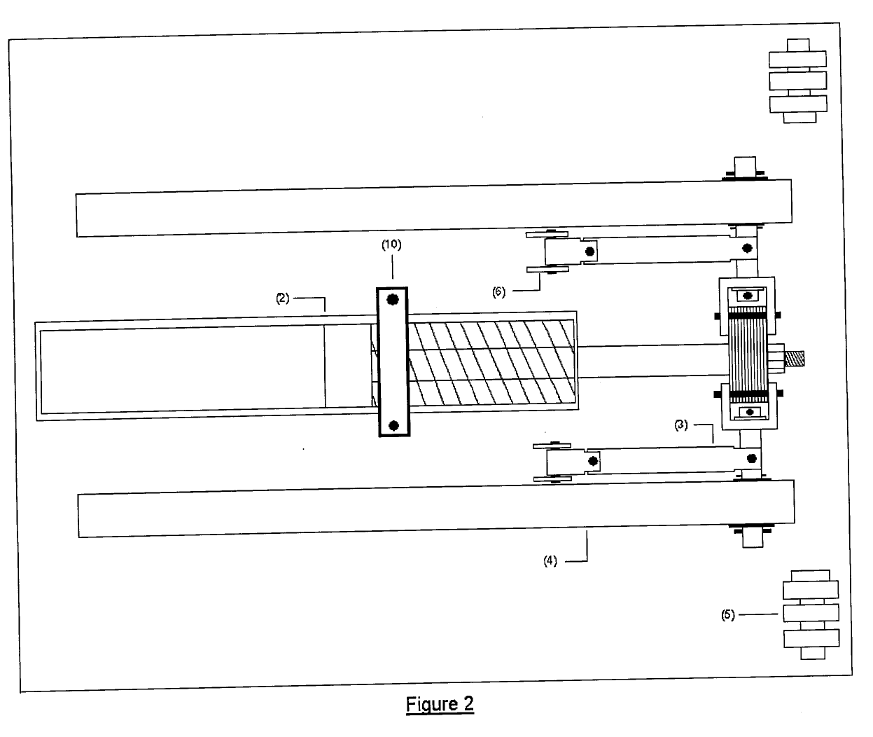

FIG. 2 is a top view showing the necessary configuration of the components. This view shows how the extension lever assembly 3 is designed with which it allows the Active Auto Foil System to be installed conforming to the shape of the area where it is installed on the vehicle. The lever guides 4, which allow the extension lever assembly 3 to slide back and forth smoothly. The actuating device 2 provides the force necessary for the extension lever assembly 3 to push on the foil mounts 6. In order that the actuating device 2 does not loose stability during operation a mid-brace 10 is installed and ensures that the moving parts are kept relatively solidly mounted. The foil hinges 5 provide solid mounting points for the foil which gives it stability when presented to the air stream moving around the vehicle.

What is claimed is:

1. An air foil system comprising:
A foil panel pushed into the air stream moving around a moving vehicle to provide ducting and or disruption of air;
Where it may assist in stopping a moving vehicle when the braking system is engaged comprising:
a secondary braking system that is mounted to said vehicle;

2. An apparatus as recited in claim 1 comprising:
An air foil being used to assist in cooling vehicle systems that attain high temperatures during said vehicles operation.

3. An apparatus as recited in claim 1 comprising:
An air foil being used to provide additional air flow into said vehicles intake system.

4. An apparatus as recited in claim 1, wherein said foil is shaped to best accentuate said vehicle.

5. An apparatus as recited in claim 1, wherein said foil is attached to a base by hinges on its leading edge side or trailing edge side.

6. An apparatus as recited in claim 1, wherein said foil is pushed into its open position by extension lever assemblies comprising:
said lever is designed in such a way that the extension lever assembly will allow the width of the system to adjust itself to fit the shape of the area it is mounted to while being mounted to said foil by means of lever to foil mounts on one end and connected to an actuating device and said base on the opposite end being adjustable on the foil panel allowing for more or less surface area of said foil panel presented to air stream.

7. An apparatus as recited in claim 6, wherein said extension lever assembly is moved by said actuating device.

8. An apparatus as recited in claim 6, wherein said actuating device to which said extension lever assembly is attached moves said lever through means of a lever guide that connects said lever to said base.

9. An apparatus as recited in claim 5, wherein said actuating device is attached to a mounting bracket on the end that is not attached to said lever and also has a mid-brace midway of the actuating device.

10. An apparatus as recited in claim 6, wherein said base is attached to said vehicle and has a protective pad placed between the foil base and the vehicle.

11. An apparatus as recited in claim 1, wherein the said foil systems measurements are determined by desired location and space available on said vehicle.

12. An apparatus as recited in claim 1, wherein said foil system has an aerodynamic cover comprising:
A pliable cover that will shape itself to the said vehicles contours and best accentuate the area said foil system is mounted on said vehicle.

13. An apparatus as recited in claim 1, wherein said actuator and said lever can be reversibly mounted being oriented 180 degrees from either position depending on desired effect of said air foil system.
